(19) United States
(12) Patent Application Publication
(10) Pub. No.: US 2020/0115041 A1
(43) Pub. Date: Apr. 16, 2020

(54) LEADING EDGE STRUCTURE FOR A FLOW CONTROL SYSTEM OF AN AIRCRAFT

(71) Applicant: Airbus Operations GmbH, Hamburg (DE)

(72) Inventor: Alexander BÜSCHER, Hamburg (DE)

(21) Appl. No.: 16/601,958

(22) Filed: Oct. 15, 2019

(30) Foreign Application Priority Data
Oct. 16, 2018 (DE) 10 2018 125 593.4

(51) Int. Cl. B64C 21/02; B64C 5/02

(52) U.S. Cl. CPC B64C 21/025; B64C 5/02

(57) ABSTRACT

A leading edge structure (11) for a flow control system of an aircraft (1) including a leading edge panel (13) surrounding a plenum (17) that extends in a span direction (19). The leading edge panel (13) has a first side portion (21) extending from a leading edge point (23) to a first attachment end (25) and a second side portion (27) opposite the first side portion (21), extending from the leading edge point (23) to a second attachment end (29), wherein the leading edge panel (13) comprises an inner surface (33) facing the plenum (17) and an outer surface (37) in contact with an ambient flow (39), and wherein the leading edge panel (13) comprises a plurality of micro pores (45) forming a fluid connection between the plenum (17) and the ambient flow (39).

### RELATED APPLICATION

This application claims priority to German Patent Application 10 2018 125 593.4, filed Oct. 16, 2018, the entirety of which is incorporated by reference.

### BACKGROUND OF INVENTION

The present invention relates to a leading edge structure for a flow control system of an aircraft, in particular for a Hybrid Laminar Flow Control system, where air is sucked in a porous surface of a flow body in order to extend the region of laminar flow along the flow body. Further aspects of the present invention relate to a vertical tail plane comprising such a leading edge structure, and an aircraft comprising such a leading edge structure or such a vertical tail plane. The leading edge structure may be part of a horizontal tail plane or of a wing for an aircraft.

The leading edge structure comprises a leading edge panel that surrounds a plenum in a curved, i.e. arcuate, manner. The plenum extends in a span direction through the leading edge structure.

When viewed in a cross section across the span direction, the leading edge panel has a first side portion extending from a leading edge point, i.e. from a fore tip of the leading edge structure, to a first attachment end on a first side of the leading edge structure, the first attachment end being configured for attachment to a further structure located downstream from the leading edge. Further, the leading edge panel has a second side portion opposite the first side portion, wherein the second side portion extends from the leading edge point to a second attachment end on a second side of the leading edge structure opposite the first side, the second attachment end being configured for attachment to a further structure downstream from the leading edge.

The leading edge panel comprises an inner surface facing the plenum and an outer surface in contact with an ambient flow. Further, the leading edge panel comprises a plurality of micro pores, such as perforations, forming a fluid connection between the plenum and the ambient flow, so that air from the ambient flow can be sucked in through the micro pores into the plenum, and, if applicable, pressurized air from the plenum can be blown out through the micro pores into the ambient flow.

Such leading edge structures are known in the art of hybrid laminar flow control systems. For cleaning the pores from liquid and other contaminants during take-off and landing approach of the associated aircraft it is known to operate the suction system in a reversed manner, i.e. to blow out air from the plenum through the micro pores into the ambient flow. For that the pressure in the plenum needs to be higher as the external pressure of the ambient flow acting on the outer surface of the leading edge panel, which is usually achieved by a door opening in a forward direction to take in air from the ambient flow and pass it into the plenum by an inlet duct. As the external pressure of the ambient flow has a maximum in the area of the leading edge point where the incoming ambient flow impinges on the outer surface of the leading edge panel in essentially perpendicular manner, the required plenum pressure for blowing out air is determined by the external pressure in the area of the leading edge point. However, at the side portions further downstream from the area of the leading edge point the external pressure is significantly lower as about the leading edge point, so that for blowing out air in these downstream areas a significantly lower plenum pressure would be sufficient.

### SUMMARY OF INVENTION

An invention is disclosed herein which may be embodied as a more efficient leading edge structure that is more precisely adapted to the requirements.

The invention may include a plenum separated by a partition wall into a leading edge plenum section in the area of the leading edge point, and a downstream plenum section downstream from the leading edge plenum section, which is further away from the leading edge point. The partition wall may extend in parallel to the span direction and is formed as a membrane e.g. of fiber reinforced plastic. Both plenum sections may be sealed from one another, so that the pressure in the leading edge plenum section does not affect the pressure in the downstream plenum section. The leading edge plenum section is connected to a first air outlet via a first duct, wherein the first air outlet is configured for causing an under-pressure in the leading edge plenum section, so that air from the ambient flow is drawn through the micro pores into the leading edge plenum section and from there discharged through the first air outlet into the ambient flow. Further, the downstream plenum section is connected to a second air outlet via a second duct, wherein the second air outlet is configured for causing an under-pressure in the downstream plenum section, so that air from the ambient flow is drawn through the micro pores into the downstream plenum section and from there discharged through the second air outlet into the ambient flow. The first air outlet is separate from the second air outlet and the first duct is separate from the second duct.

In such a way, an individual pressure can be applied in the leading edge plenum section and in the downstream plenum section, respectively, and different approaches for cleaning the pores can be realized in the leading edge area and in the area downstream from the leading edge area, depending on the respective pressure level.

The partition wall may be arranged at between 10% and 50%, between 20% and 30% of the downstream length of the plenum, measured from the leading edge point in the downstream direction.

According to a first embodiment of the invention, the first air outlet comprises a pivotal first door that opens in a rearward direction, i.e. forming a rearward-facing opening. The first door may pivot to the outside into the ambient flow with a pivot axis at the front end of the first door. The first door is configured to be set to a closed position where no mass flow of air can pass to the ambient flow, and to an opened position corresponding to a predefined opening angle for letting out a predefined mass flow rate of air adapted for flow control, i.e. for sucking in boundary layer through the micro pores, in the area of the leading edge. Under various conditions, the pressure of the incoming ambient flow acting on the leading edge panel is so high in the leading edge area that the micro pores are essentially cleaned already by the suction operation for flow control, so that no additional cleaning function is provided for the leading edge area in this embodiment. In such a way, the system can be simplified and weight can be saved.

In a second embodiment of the invention, the first air outlet comprises a pivotal first door that opens in a rearward direction, i.e. forming a rearward-facing opening. The first door may pivot to the outside into the ambient flow with a pivot axis at the front end of the first door. The first door is configured to be set to a closed position where no mass flow of air can pass to the ambient flow, to a first opened position corresponding to a predefined first opening angle for letting out a predefined first mass flow rate of air adapted for flow control, i.e. for sucking in boundary layer through the micro pores, in the area of the leading edge, and to a second opened position corresponding to a predefined second opening angle for letting out a predefined second mass flow rate of air adapted for cleaning the micro pores in the area of the leading edge from liquid and other contaminants during take-off and landing approach of the associated aircraft. The second mass flow rate is essentially greater than the first mass flow rate. In such a way, an additional cleaning function for the leading edge area is included. Instead of blowing air out through the micro pores cleaning is performed by sucking air from the ambient flow into the plenum similar to the flow control suction operation, but with a greater mass flow rate.

In particular, the second mass flow rate may be between 200% and 400% or greater, such as between 250% and 350% or greater, and such as 300% or greater than the first mass flow rate. In such a way, an effective cleaning of the micro pores can be achieved.

The second air outlet may include a pivotal second door that opens in a rearward direction, i.e. forming a rearward-facing opening. The second door may pivot to the outside into the ambient flow with a pivot axis at the front end of the second door. The second door is configured to be set to a closed position where no mass flow of air can pass to the ambient flow, to a first opened position corresponding to a predefined third opening angle for letting out a predefined third mass flow rate of air adapted for flow control, i.e. for sucking in boundary layer through the micro pores, in the area downstream from the leading edge area, and to a second opened position corresponding to a predefined fourth opening angle for letting out a predefined fourth mass flow rate of air adapted for cleaning the micro pores in the area downstream from the leading edge area from liquid and other contaminants during take-off and landing approach of the associated aircraft. The fourth mass flow rate is essentially greater than the third mass flow rate. In such a way, a cleaning function for the area downstream from the leading edge area is included. Instead of blowing air out through the micro pores cleaning is performed by sucking air from the ambient flow into the plenum similar to the flow control suction operation, but with a greater mass flow rate.

In particular, the fourth mass flow rate may be between 200% and 400% or greater, between 250% and 350% or greater, or 300% or greater than the third mass flow rate. Also, the first mass flow rate may be greater than third mass flow rate and/or the second mass flow rate is greater than fourth mass flow rate. In such a way, an effective cleaning of the micro pores can be achieved.

The second air outlet may be formed as a combined, hybrid air inlet/outlet device configured for both letting in air from the ambient flow and discharging air into the ambient flow. With such a combined air inlet/outlet device both inlet and outlet function can be combined in one device so that no separate air inlet and air outlet are necessary, thereby reducing complexity, weight and space requirements of the leading edge structure. Further, no sealing of a flap that is not in operation has to be considered. In contrast to the second air outlet, the first air outlet may not include any air inlet function but is an outlet only.

In particular, the air inlet/outlet device may comprises a pivoting inlet door opening in a forward direction, i.e. forming a forward-facing opening, to let in air from the ambient flow and pass it to the downstream plenum section and finally blow it out through the micro pores. The inlet door may pivot to the inside of the leading edge structure with a pivot axis at the front end of the inlet door. The air inlet/outlet device further comprises a pivoting outlet door opening in a rearward direction, i.e. forming a rearward-facing opening, to discharge air from the downstream plenum section into the ambient flow. The outlet door may pivot to the outside into the ambient flow with a pivot axis at the front end of the outlet door. The inlet door may be configured to be set to a closed position where any mass flow of air from the ambient flow to the second duct is inhibited, and to an opened position corresponding to a predefined opening angle for letting in a predefined mass flow rate of air adapted for cleaning the micro pores in the area downstream from the leading edge area from liquid and other contaminants during take-off and landing approach of the associated aircraft. Likewise, the outlet door may be configured to be set to a closed position where any mass flow of air from the second duct to the ambient flow is inhibited, and to an opened position corresponding to a predefined opening angle for letting out a predefined mass flow rate of air adapted for flow control, i.e. for sucking in boundary layer through the micro pores, in the area downstream from the leading edge area. In such a way, an effective air inlet/outlet device is provided.

The inlet door and the outlet door may be formed integrally or are mounted to one another. Alternatively, the inlet door and the outlet door may also be provided separately at opposite sides of the leading edge structure or of a corresponding vertical tail plane.

The leading edge structure may further comprise a back wall connecting the first attachment end to the second attachment end of the leading edge panel, thereby enclosing the plenum, specifically the downstream plenum section, on a side opposite the leading edge point. The back wall may be parallel to the partition wall and is formed as a membrane e.g. of fiber reinforced plastic.

The leading edge panel may have a double-walled form including an inner wall element having the inner surface and, spaced apart from the inner wall element, an outer wall element having the outer surface. Such a double-walled form provides advantageous mechanical properties.

Between the inner and outer wall elements, the leading edge panel may comprise a plurality of elongate stiffeners connecting the inner and outer wall elements and spaced apart from one another, so that between each pair of adjacent stiffeners a hollow chamber is formed between the inner and outer wall elements. The stiffeners may be formed integrally with the inner wall element, extend in the span direction, and have a solid and/or square-shaped or trapezoid-shaped cross section. Further, the inner wall element may be formed of a fiber reinforced plastic (FRP), the stiffeners are formed as sandwich structures, and the outer wall element is formed as a titanium or steel sheet. In such a way, a simple and reliable double-walled structure is provided.

The outer wall element may comprise the plurality of micro pores forming a fluid connection between the hollow chambers and the ambient flow. In particular, the outer wall element comprises multiple sections, wherein the porosity varies from one section to another section in terms of pore diameter and/or pore pitch. The inner wall element comprises openings forming a fluid connection between the hollow chambers and the plenum, in particular between the leading edge plenum section and the corresponding hollow chambers, and between the downstream plenum section and the corresponding hollow chambers. Each hollow chamber may comprise at least one opening. The openings may be formed as throttle holes having a predefined diameter adapted for a predefined mass flow rate through the throttle holes in order to achieve a predefined fluid pressure in the hollow chambers. Alternatively, the openings may be formed as simple holes having such a diameter that essentially the same pressure is present in the hollow chambers as in the plenum.

The invention may be embodied in a vertical tail plane for an aircraft. The vertical tail plane comprises a vertical tail plane box and a leading edge structure according to any of the embodiments described herein. The vertical tail plane box has a first lateral panel with a first attachment portion and an opposite second lateral panel with a second attachment portion. The first attachment end of the leading edge structure is attached to the first attachment portion and the second attachment end is attached to the second attachment portion, so that the first side portion of the leading edge panel forms a continuous flow surface with the first lateral panel of the vertical tail plane box and the second side portion of the leading edge panel forms a continuous flow surface with the second lateral panel of the vertical tail plane box. The features and advantageous described in connection with the leading edge structure apply vis-à-vis to the vertical tail plane.

The first air inlet and/or the second air inlet may be arranged in the first lateral panel and/or in the second lateral panel and/or in another leading edge panel arranged beside the leading edge structure in the span direction. The first and second ducts may extend through the space between the vertical tail plane box and other the leading edge panel. The first air outlet and the second air outlet may be arranged on opposite sides of the vertical tail plane.

A further aspect of the present invention relates to an aircraft comprising a leading edge structure according to any of the embodiments described herein, or comprising a vertical tail plane according to any of the embodiment described herein. The features and advantageous described in connection with the leading edge structure and with the vertical tail plane apply vis-a-vis to the aircraft.

The aircraft may further comprise a control unit configured to control the aircraft to operate in a flow control mode by setting the first door to the opened position, the inlet door to the closed position, and the outlet door to the opened position, and in a cleaning mode by setting the first door to the opened position, the inlet door to the opened position, and the outlet door to the closed position. In case that the first door has two opened positions, as described above in connection with one embodiment, the control unit is configured to control the aircraft to operate in a flow control mode by setting the first door to the first opened position, the inlet door to the closed position, and the outlet door to the opened position, and in a cleaning mode by setting the first door to the second opened position, the inlet door to the opened position, and the outlet door to the closed position.

### SUMMARY OF THE DRAWINGS

An embodiment(s) of the present invention is described hereinafter in more detail by means of a drawing. The drawing shows in

FIG. 1 a perspective view of an aircraft according to the invention,

FIG. 2 a side view of a vertical tail plane according to the invention, and

FIG. 3 a cross sectional view across the span direction of a leading edge structure according to the invention.

### DETAILED DESCRIPTION OF AN EMBODIMENT(S) OF THE INVENTION

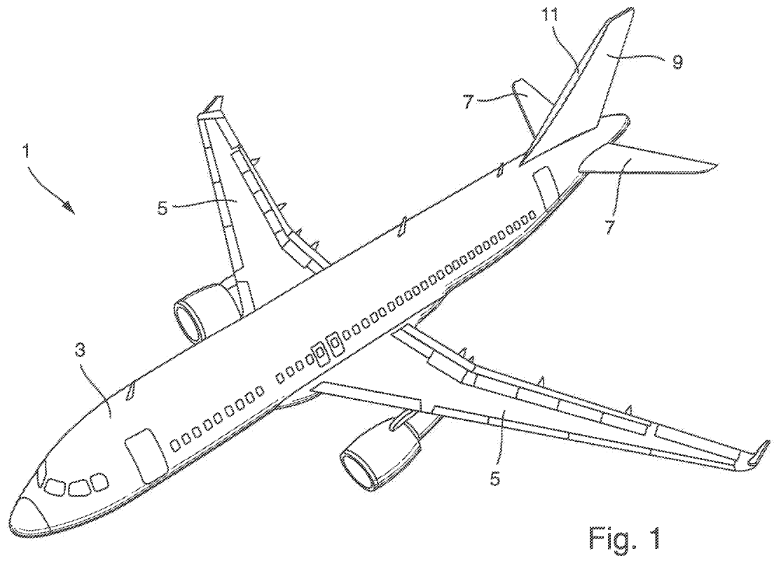

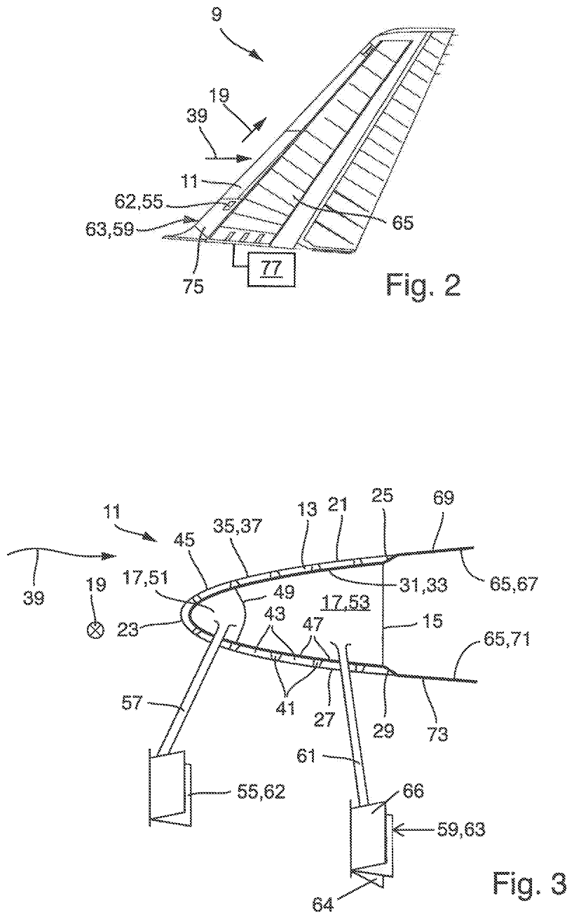

In FIG. 1 an aircraft 1 according to an embodiment of the present invention is shown. The aircraft comprises a fuselage 3, wings 5, a horizontal tail plane 7, and a vertical tail plane 9 according to an embodiment of the invention. The vertical tail plane 9 is shown in more detail in FIG. 2. The vertical tail plane 9 comprises a leading edge structure 11 according to an embodiment of the invention. The leading edge structure 11 is shown in more detail in FIG. 3.

The leading edge structure 11 is configured for a hybrid laminar flow control system and comprises a leading edge panel 13 and a back wall 15. The leading edge panel 13 surrounds a plenum 17 in a curved manner. The plenum 17 extends in a span direction 19 through the leading edge structure 11. When viewed in a cross section across the span direction 19, the leading edge panel 13 has a first side portion 21 extending from a leading edge point 23 to a first attachment end 25 on a first side of the leading edge structure 11. Further, the leading edge panel 13 has a second side portion 27 opposite the first side portion 21, wherein the second side portion 27 extends from the leading edge point 23 to a second attachment end 29 on a second side of the leading edge structure 11 opposite the first side. The back wall 15 connects the first attachment end 25 to the second attachment end 29 of the leading edge panel 13, thereby enclosing the plenum 17 on a side opposite the leading edge point 23.

The leading edge panel 13 has a double-walled form including an inner wall element 31 having an inner surface 33 facing the plenum 17, and an outer wall element 35 having an outer surface 37 in contact with an ambient flow 39. Between the inner and outer wall elements 31, 35 the leading edge panel 13 comprises a plurality of elongate stiffeners 41 extending in the span direction 19 and spaced apart from one another, so that between each pair of adjacent stiffeners 41 a hollow chamber 43 is formed between the inner and outer wall elements 31, 35. The stiffeners 41 are formed integrally with the inner wall element 31 in a sandwich form and have a solid, trapezoid-shaped cross section. The inner wall element 31 is formed of a fiber reinforced plastic (FRP). The outer wall element 35 is formed as a titanium sheet and comprises a plurality of micro pores 45 forming a fluid connection between the hollow chambers 43 and the ambient flow 39. The inner wall element 31 comprises openings 47 forming a fluid connection between the hollow chambers 43 and the plenum 17.

As shown in FIG. 3, the plenum 17 is separated by a partition wall 49 into a leading edge plenum section 51 in the area of the leading edge point 23, and a downstream plenum section 53 downstream from the leading edge plenum section 51. The partition wall 49 extends in parallel to the span direction 19 and is formed as a membrane of fiber reinforced plastic. Both plenum sections 51, 53 are sealed from one another, so that the pressure in the leading edge plenum section 51 does not affect the pressure in the downstream plenum section 53. The leading edge plenum section 51 is connected to a first air outlet 55 via a first duct 57 for discharging air to the ambient flow 39. Further, the downstream plenum section 53 is connected to a second air outlet 59 via a second duct 61 for discharging air to the ambient flow 39. The first air outlet 55 is separate from the second air outlet 59 and the first duct 57 is separate from the second duct 61.

The first air outlet 55 comprises a pivotal first door 62 that opens in a rearward direction and that is configured to be set to a closed position, where no mass flow of air can pass to the ambient flow 39, and to an opened position corresponding to a predefined opening angle for letting out a predefined mass flow rate of air from the leading edge plenum section 51 adapted for flow control.

The second air outlet 59 is formed as combined air inlet/outlet devices 63 configured for both letting in air from the ambient flow 39 and discharging air into the ambient flow 39. The air inlet/outlet device 63 comprises a pivotal inlet door 64 opening in a forward direction to let in air from the ambient flow 39 and pass it to the downstream plenum section 53 and finally blow it out through the micro pores 45. The air inlet/outlet device 63 further comprises a pivotal outlet door 66 opening in a rearward direction to discharge air from the downstream plenum section 53 into the ambient flow 39. The inlet door 64 is configured to be set to a closed position where any mass flow of air from the ambient flow 39 to the second duct 61 is inhibited, and to an opened position corresponding to a predefined opening angle for letting in a predefined mass flow rate of air adapted for cleaning the micro pores 45 in the area downstream from the leading edge area from liquid and other contaminants during take-off and landing approach of the associated aircraft 1. Likewise, the outlet door 66 is configured to be set to a closed position where any mass flow of air from the second duct 61 to the ambient flow 39 is inhibited, and to an opened position corresponding to a predefined opening angle for letting out a predefined mass flow rate of air adapted for flow control in the area downstream from the leading edge area. The inlet door 64 and the outlet door 66 are formed integrally as one common door that is pivotable inwards to the inside of the vertical tail plane 9 as well as outwards into the ambient flow 39.

As shown in FIGS. 2 and 3, the vertical tail plane 9 comprises a vertical tail plane box 65 and the leading edge structure 11 is mounted to the vertical tail plane box 65. The vertical tail plane box 65 has a first lateral panel 67 with a first attachment portion 69 and an opposite second lateral panel 71 with a second attachment portion 73. The first attachment end 25 of the leading edge structure 11 is attached to the first attachment portion 69 and the second attachment end 29 is attached to the second attachment portion 73, so that the first side portion 21 of the leading edge panel 13 forms a continuous flow surface with the first lateral panel 67 of the vertical tail plane box 65 and the second side portion 27 of the leading edge panel 13 forms a continuous flow surface with the second lateral panel 71 of the vertical tail plane box 65. The first air inlet 55 and the second air inlet 59 are arranged on opposite sides in another leading edge panel 75 beside the leading edge structure 11 with respect to the span direction 19. The first and second ducts 57, 61 extend through the space between the vertical tail plane box 65 and the other leading edge panel 75.

The aircraft further comprises a control unit 77 configured to control the aircraft 1 to operate in a flow control mode by setting the first door 62 to the opened position, the inlet door 64 to the closed position, and the outlet door 66 to the opened position, and in a cleaning mode by setting the first door 62 to the opened position, the inlet door 64 to the opened position, and the outlet door 66 to the closed position.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A leading edge structure for a flow control system of an aircraft, the leading edge structure comprising
a leading edge panel that surrounds a plenum in a curved manner, the plenum extending in a span direction,
wherein the leading edge panel has a first side portion extending from a leading edge point to a first attachment end,
wherein the leading edge panel has a second side portion opposite the first side portion, extending from the leading edge point to a second attachment end,
wherein the leading edge panel comprises an inner surface facing the plenum and an outer surface in contact with an ambient flow, and
wherein the leading edge panel comprises a plurality of micro pores forming a fluid connection between the plenum and the ambient flow,
wherein the plenum is separated by a partition wall into a leading edge plenum section in an area adjacent the leading edge point, and a downstream plenum section downstream from the leading edge plenum section,
the leading edge plenum section is connected to a first air outlet via a first duct,
the downstream plenum section is connected to a second air outlet via a second duct, and
the first air outlet is separate from the second air outlet and the first duct is separate from the second duct.

2. The leading edge structure according to claim 1, wherein the first air outlet comprises a pivotal first door that opens in a rearward direction, wherein the first door is configured to be set to an opened position for letting out a predefined mass flow rate of air adapted for flow control in the area of the leading edge.

3. The leading edge structure according to claim 1, wherein the first air outlet comprises a pivotal first door that opens in a rearward direction,
wherein the first door is configured to be set to a first opened position for letting out a predefined first mass flow rate of air adapted for flow control in the area of the leading edge, and to a second opened position for letting out a predefined second mass flow rate of air adapted for cleaning the micro pores in the area of the leading edge.

4. The leading edge structure according to claim 3, wherein the second mass flow rate is between 200% and 400% greater than the first mass flow rate.

5. The leading edge structure according to claim 1, wherein the second air outlet comprises a pivotal second door that opens in a rearward direction, wherein the second door is configured to be set to a first opened position for letting out a predefined third mass flow rate of air adapted for flow control in the area downstream from the leading edge area, and to a second opened position for letting out a predefined fourth mass flow rate of air adapted for cleaning the micro pores in the area downstream from the leading edge area.

6. The leading edge structure according to claim 5, wherein the fourth mass flow rate is between 200% and 400% greater than the third mass flow rate.

7. The leading edge structure according to claim 1, wherein the second air outlet is formed as a combined air inlet/outlet device configured for both letting in air from the ambient flow and discharging air into the ambient flow.

8. The leading edge structure according to claim 7, wherein the air inlet/outlet device comprises a pivoting inlet door opening in a forward direction to let in air from the ambient flow, and an outlet door opening in a rearward direction to discharge air into the ambient flow,
wherein the inlet door is configured to be set to an opened position for letting in a predefined mass flow rate of air adapted for cleaning the micro pores in the area downstream from the leading edge area, and
wherein the outlet door is configured to be set to an opened position for letting out a predefined mass flow rate of air adapted for flow control in the area downstream from the leading edge area.

9. The leading edge structure according to claim 8, wherein the inlet door and the outlet door are formed integrally or are mounted to one another.

10. A vertical tail plane for an aircraft comprising
a vertical tail plane box having a first lateral panel with a first attachment portion and an opposite second lateral panel with a second attachment portion;
a leading edge structure including:
a curved leading edge panel at least partially surrounding a plenum extending in a span direction;
wherein the leading edge panel has a first side portion extending from a leading edge point to a first attachment end;
wherein the leading edge panel has a second side portion opposite the first side portion, extending from the leading edge point to a second attachment end;
wherein the leading edge panel comprises an inner surface facing the plenum and an outer surface in contact with an ambient flow;
wherein the leading edge panel comprises a plurality of micro pores forming a fluid connection between the plenum and the ambient flow;
wherein the plenum is separated by a partition wall into a leading edge plenum section in an area adjacent the leading edge point, and a downstream plenum section downstream from the leading edge plenum section;
wherein the leading edge plenum section is connected to a first air outlet via a first duct,
wherein the downstream plenum section is connected to a second air outlet via a second duct, and
the first air outlet is separate from the second air outlet and the first duct is separate from the second duct,
wherein the first attachment end is attached to the first attachment portion, and wherein the second attachment end is attached to the second attachment portion, so that the first side portion of the leading edge panel forms a continuous flow surface with the first lateral panel of the vertical tail plane box, and the second side portion of the leading edge panel forms a continuous flow surface with the second lateral panel of the vertical tail plane box.

11. The vertical tail plane according to claim 10, wherein the first air outlet and/or the second air outlet is arranged in the first lateral panel and/or in the second lateral panel and/or in another leading edge panel arranged beside the leading edge structure in the span direction.

12. An aircraft comprising the leading edge structure according to claim 10.

13. The aircraft according to claim 12, further comprising a control unit configured to control the aircraft to operate in a flow control mode by setting the first door to the opened position, the inlet door to the closed position, and the outlet door to the opened position, and in a cleaning mode by setting the first door to the opened position, the inlet door to the opened position, and the outlet door to the closed position.

14. A vertical tail plane for an aircraft comprising
a vertical tail plane box having a first lateral panel including a first attachment portion and a second lateral panel with a second attachment portion, wherein the second lateral panel is opposite to the first later panel;
a leading edge structure attached to the vertical tail plane box, the leading edge structure including a first leading edge panel extending from a leading edge of the vertical tail plane to the first attachment portion, and a second leading edge panel extending from the leading edge to the second attachment portion, wherein the second leading edge panel is opposite the first leading edge panel;
a plenum defined, at least partially, by inner surfaces of the first and second leading edge panels, wherein the plenum includes a leading edge plenum section adjacent the leading edge, a partition wall aft of the leading edge and extending between the first and second leading edge panels, and a downstream plenum section aft of the partition wall;
micro pores in the first and second leading edge panels, the micro pores configured for fluid communication between ambient air flowing over the leading edge structure and air within the leading edge plenum section and the downstream plenum section;
a first air outlet in fluid communication with the leading edge plenum via a first duct; and
a second air outlet in fluid communication with the downstream plenum via a second duct, wherein the second air outlet and the second duct are from the first air outlet and the first duct.

15. The vertical tail plane of claim 14, wherein the first air outlet includes a first door on an outer surface of the vertical tail plane and configured to open to form an opening into the first duct downstream of the first door.

16. The vertical tail plane of claim 15, wherein the first door is configured to open to a first opened position and a second open position, wherein an air mass flow rate through the first duct is 200% and 400% greater while the first door is in the second position as compared to a mass flow rate through the first duct while the first door is in the first position.

17. The vertical tail plane of claim 14, wherein the second air outlet includes a second door configured to form an opening to the second duct, wherein the second door is configured to be opened to a first position in which the second door deflects ambient air into the second duct and to a second position in which the second door deflects ambient air away from the second duct.

18. The vertical tail plane of claim 17, wherein the second door is for both directing ambient air into the second duct and for discharging air from the plenum into the ambient flow.

19. The vertical tail plane of claim 17, wherein the second door configured to, while in the first position, open in a forward direction to face the ambient air and thereby direct ambient air into the second duct, and, while in the second position, open in a rearward direction such that the opening to the second duct is downstream of the second door.

20. The vertical tail plane of claim 19, wherein second door includes an inlet door to be opened in the first position and the outlet door to be opened in the second position.
